(19) United States
(12) Patent Application Publication
(10) Pub. No.: US 2017/0272376 A1
(43) Pub. Date: Sep. 21, 2017

(54) PACKET ORDER IDENTIFICATION WITH REDUCED OVERHEAD IN PACKETIZED DATA TRANSMISSION

(71) Applicant: PHILIPS LIGHTING HOLDING B.V., Eindhoven (NL)

(72) Inventor: ROBERT JAMES DAVIES, EINDHOVEN (NL)

(21) Appl. No.: 15/529,853

(22) PCT Filed: Nov. 13, 2015
(86) PCT No.: PCT/EP2015/076494

§ 371 Date: May 25, 2017

(30) Foreign Application Priority Data
Nov. 27, 2014 (EP) 14195073.3

(51) Int. Cl. H04L 12/863; H04L 29/06; H04L 12/18

(52) U.S. Cl. CPC H04L 47/624; H04L 12/1881; H04L 69/22; H04L 1/0056

(57) ABSTRACT

A transmitting device comprising: a transmitter for transmitting data to a receiving device; and a controller for formatting the data to be transmitted from the transmitter, by dividing the data amongst a plurality of packets. The controller is configured to package each respective one of the packets with only a respective portion of an index sequence as an identifier field for distinguishing between the packets within the sequence, wherein at least one of the portions is alone insufficient to identify its respective packet. The controller is further configured to control the transmitter to transmit the packets including the respective portions of the index sequence, ordered such that the index sequence repeats cyclically over the transmission of the packets; thereby enabling the receiving device to determine a respective position in the index sequence for each of the packets by referencing a plurality of the portions together, and to thereby identify the packets.

### TECHNICAL FIELD

The present disclosure relates to a transmitting device such as a luminaire equipped to modulate data into the light it emits. Particularly, the present disclosure relates to the packaging of messages for transmission from such a device.

### BACKGROUND

Modern luminaires incorporate not only the components necessary to drive the luminous element (e.g. a LED string), but are also capable of integrating significant additional functionality, e.g. including network connectivity and/or sensors of various kinds. Coded light refers to techniques whereby data is embedded in the light emitted by a light source such as an everyday luminaire, by varying the output of the light source in accordance with a suitable signaling method. The light typically comprises both a visible illumination contribution for illuminating a target environment such as room (typically the primary purpose of the light), and an embedded signal for providing information into the environment. To do this, the light is modulated at a certain modulation frequency or frequencies, preferably a high enough frequency so as to be beyond human perception and therefore not affecting the primary illumination function. Data can then be encoded into the light by varying a property of the modulation, e.g. the frequency of the modulation, the amplitude of the modulation, or the phase of the modulation. Thus coded light provides a free-space optical communications technology that can be added as an extension to existing luminaire designs.

Coded light can be detected using an everyday ‘rolling shutter’ type camera, as is often integrated into a mobile device like a mobile phone or tablet. In a rolling-shutter camera, the camera's image capture element is divided into a plurality of lines (typically horizontal lines, i.e. rows) which are exposed in sequence line-by-line. That is, to capture a given frame, first one line is exposed to the light in the target environment, then the next line in the sequence is exposed at a slightly later time, and so forth. Typically the sequence ‘rolls’ in order across the frame, e.g. in rows top to bottom, hence the name ‘rolling shutter’. When used to capture coded light, this means different lines within a frame capture the light at different times and therefore, if the line rate is high enough relative to the modulation frequency, at different phases of the modulation waveform. Thus the modulation in the light can be detected. Coded light can also be detected by using a global shutter camera if the frame rate is high enough relative to the modulation frequency, or using a dedicated photocell with suitable sample rate.

A luminaire that supports transmission of coded light signals can enable many applications of interest, including commissioning, personal control and indoor positioning.

For example, the data embedded in the illumination emitted by a luminaire may comprise an identifier of that luminaire. This identifier can then be used in a commissioning phase to identify the contribution from each luminaire, or during operation can be used to identify a luminaire in order to control it remotely (e.g. via an RF back channel). In another example, the identification can be used for navigation or other location-based functionality, by providing a mapping between the identifier and a known location of the luminaire, and/or other information associated with the location. In this case a device such as a mobile phone or tablet which receives the light (e.g. through a built-in camera) can detect the embedded identifier and use it to look up the corresponding location and/or other information mapped to the identifier (e.g. in a location database accessed over a network such as the Internet). In yet further applications, other information can be directly encoded into the light (as opposed to being looked up based on an ID embedded in the light).

### SUMMARY

However, in a resource-constrained communication system such as a coded light system, it is not always possible or at least not always desirable to communicate packets that are too long. For instance, when detecting coded light using a rolling-shutter camera, the image capture element only has a finite number of lines with which to capture the modulation in the light. I.e. the data is captured over a sequence of lines, each capturing the coded light at a slightly different time and hence a slightly different stage of the modulation (e.g. see the discussion later in relation to FIGS. 3 and 4). This means that one full sequence (one frame) only lasts a finite amount of time, and so in itself will only be able to “see” a message of a certain finite length (assuming each bit lasts a certain bit period, the number of bits corresponds to a certain length in time). For efficient capture it may be desired that a complete packet is captured over only a single frame or perhaps a small number of frames (it is possible to stitch together parts of a packet captured over multiple frames, but this involves a more complex reassembly (also known as stitching) algorithm which consumes processing resources and incurs extra processing time). Furthermore, often the coded light source may only appear in a limited area of the frame (a limited “footprint”), so only cover a small number of the lines, reducing even further the packet size that can be seen in a single frame (or a certain predetermined small number of frames).

On the other hand, it may be desired to send a message that is larger than this packet size. For instance in the case of a coded light luminaire emitting an ID of itself (e.g. as part of an indoor location system), then if the ID is to be globally unique throughout the entire world (and future-proofed as such), a payload of the order of 128 bits may be required. It will be appreciated that this is just one example and there are many other types of message which it may be desired to send in many other types of system.

Taking into account the considerations above, it may therefore be desired to divide data to be transmitted between multiple small packets. E.g. to send a 128 bit payload, this may be divided between 16 packets each of 8 bits each (an octet, often referred to as a byte). However, this in itself incurs extra bits in that each of the packets needs to be given an identifier field in order to identify which of the multiple packets it is. E.g. in the example above, using conventional techniques a 4-bit identifier field would be incurred for each of the 16 packets. But even a single spare bit can be hard to find, and four bits even more so.

Similar considerations may also be encountered in other resource-constrained communication systems, not just limited to rolling-shutter cameras or even coded light, depending on the constraints of the protocol, transmission medium, transmitter and/or receiver.

The following provides a technique for identifying packets with a reduced overhead in a given packet. It is based on the principle of trading off bit capacity for time taken to determine one's position in the packet sequence.

According to one aspect disclosed herein, there is provided a transmitting device comprising: a transmitter for transmitting data to a receiving device; and a controller for formatting the data to be transmitted from the transmitter, by dividing the data amongst a plurality of packets. E.g. the transmitting device may comprise a light source such as a luminaire, and the receiving device may comprise a light sensor such as a rolling-shutter camera. The controller is configured to package each respective one of the packets with only a respective portion of an index sequence as an identifier field for distinguishing between the packets within the sequence, wherein at least one of the portions is alone insufficient to identify its respective packet. In embodiments, each of these portions is of a fixed size, and may even be only a single bit. Preferably the plurality of the portions that are used to determine a respective position in the index sequence are consecutive portions of the plurality of portions. The controller is further configured to control the transmitter to transmit the packets including the respective portions of the index sequence, ordered such that the index sequence repeats cyclically over the transmission of the packets; thereby enabling the receiving device to determine a respective position in the index sequence for each of the packets by referencing a plurality of the portions together, and to thereby identify the packets.

According to another aspect disclosed herein, there is provided a receiving device comprising: a receiver for receiving data from a transmitting device, the data being received divided amongst a plurality of packets; and a decoder for extracting the data from the packets. Each respective one of the packets is received packaged with only a respective portion of an index sequence (e.g. only a single bit or single symbol) as an identifier field for distinguishing between the packets within the sequence, wherein at least one of the portions is alone insufficient to identify its respective packet. The decoder is configured to determine a respective position in the index sequence for each of the packets by referencing a plurality of the portions together, and to thereby identify the packets in order to extract the data.

In embodiments, over each repetition of the index sequence, the data of each respective packet may comprise of a different respective part of an overall payload. E.g. the payload may comprise an ID of the transmitting device (such as a 128 bit ID, which may be globally unique). In embodiments, the overall payload may repeat with each repetition of the index sequence.

In embodiments the decoder is configured to determine the position in the sequence by: for each one of said packets (i.e. each target packet whose position is to be determined), determining a respective index value by combining (in embodiments concatenating) the respective portion of the index sequence (e.g. the respective index bits) with the respective index portions (e.g. respective index bits) received in a plurality of others of the received packets at predetermined points in the index sequence relative to said one of the packets wherein the index value gives an unambiguous position within the index sequence (i.e. appears at only one position in the sequence). For example the index portions of the other packets may be a certain number of preceding index portions at predetermined points in the sequence relative to that of the target packet, such as the immediately N preceding index portions (i.e. the index portion of the adjacent preceding packet, and the adjacent preceding packet before that, and so on).

To give an example of how such a scheme works, consider the case of the 128 bit payload divided amongst 16 packets. Although using a single bit it is not possible to determine one's position in the sequence from a single transmission, it is possible to do so from four successive transmissions. This is so because the single bit is arranged to follow a predetermined sequence having the property that (in this example) any four successive bits within a cycle of 16 exhibits a different 4-bit pattern. Thus, the pattern that emerges from four transmissions is enough to give an index.

In embodiments, the index sequence may be a Maximum Length Sequence or a derivative thereof. In embodiments, the index sequence may be the result of a linear feedback shift register.

In embodiments, the decoder may be configured to detect that an earlier determination of the position was incorrect, based on detecting that that the respective index value is illegal within the sequence or that the respective index value of one or more later packets is inconsistent relative to the respective index value of one or more earlier packets in context of said index sequence. That is, the decoder can “backtrack” and tell that there has previously been an error in the tracking of the sequence (e.g. due to a lost packet meaning that one of the index portions was lost).

According to another aspect disclosed herein, there is provided a system comprising the transmitter and receiver.

According to another aspect disclosed herein, there is provided a computer program product comprising code embodied on one or more computer-readable storage media and/or being downloadable therefrom, and being configured so as when run on a transmitting device to perform operations of: formatting data to be transmitted from the transmitting device to a receiving device, by dividing the data amongst a plurality of packets; packaging each respective one of the packets with only a respective portion of an index sequence as an identifier field for distinguishing between the packets within the sequence, wherein at least one of the portions is alone insufficient to identify its respective packet; and transmitting the packets including the respective portions of the index sequence, ordered such that the index sequence repeats cyclically over the transmission of the packets; thereby enabling the receiving device to determine a respective position in the index sequence for each of the packets by referencing a plurality of the portions together, and to thereby identify the packets.

According to another aspect disclosed herein, there is provided a computer program product comprising code embodied on one or more computer-readable storage media and/or being downloadable therefrom, and being configured so as when run a receiving device to perform operations of: receiving data from a transmitting device, the data being received divided amongst a plurality of packets, wherein each respective one of the packets is received packaged with only a respective portion of an index sequence as an identifier field for distinguishing between the packets within the sequence, such that at least one of the portions is alone insufficient to identify its respective packet; and determining a respective position in the index sequence for each of the packets by referencing a plurality of the portions together, to thereby identify the packets and extract the data based on said identification.

According to another aspect disclosed herein, there is provided a method of transmitting data to a receiving device, the method comprising: formatting data to be transmitted to the receiving device, by dividing the data amongst a plurality of packets; packaging each respective one of the packets with only a respective portion of an index sequence as an identifier field for distinguishing between the packets within the sequence, wherein at least one of the portions is alone insufficient to identify its respective packet; and transmitting the packets including the respective portions of the index sequence, ordered such that the index sequence repeats cyclically over the transmission of the packets, thereby enabling the receiving device to determine a respective position in the index sequence for each of the packets by referencing a plurality of the portions together and to thereby identify the packets.

According to another aspect disclosed herein, there is provided a method of receiving data from a transmitting device, the method comprising: receiving data from the transmitting device, the data being received divided amongst a plurality of packets, wherein each respective one of the packets is received packaged with only a respective portion of an index sequence as an identifier field for distinguishing between the packets within the sequence, such that at least one of the portions is alone insufficient to identify its respective packet; and determining a respective position in the index sequence for each of the packets by referencing a plurality of the portions together, to thereby identify the packets and extract the data based on said identification.

In embodiments, any of these transmitting and receiving devices, programs and/or methods may be further configured in accordance with any of the features disclosed herein.

### BRIEF DESCRIPTION OF THE DRAWINGS

To assist understanding of the present disclosure and to show how embodiments may be put into effect, reference will be made by way of example to the accompanying drawings in which:

FIG. 1 is a schematic illustration of an environment including a lighting system,

FIG. 2 is a schematic block diagram of a transmitting device and receiving device,

FIG. 3 schematically illustrates an image capture element of a rolling-shutter camera,

FIG. 4 schematically illustrates the capture of modulated light by rolling shutter,

FIG. 5 is a schematic diagram of a linear feedback shift register (LFSR),

FIG. 6 is a schematic diagram of some different packet protocols, and

FIG. 7 is another schematic diagram of a packet protocol.

### DETAILED DESCRIPTION OF EMBODIMENTS

As discussed, modern luminaires incorporate not only the components necessary to drive the luminous element (e.g., a LED string), but are also capable of integrating significant additional functionality, including network connectivity and sensors of various kinds. One such function is the transmission of information by modulation of the light emitted by the luminous element. This may be achieved by varying the light intensity in some manner, though other methods are known, such as varying the frequency or phase of the modulation. There are a number of uses for such a transmission function, such as the transmission of an identifier signal that allows a receiver to identify the source of the light. This enables such applications as indoor positioning, lighting control and system commissioning.

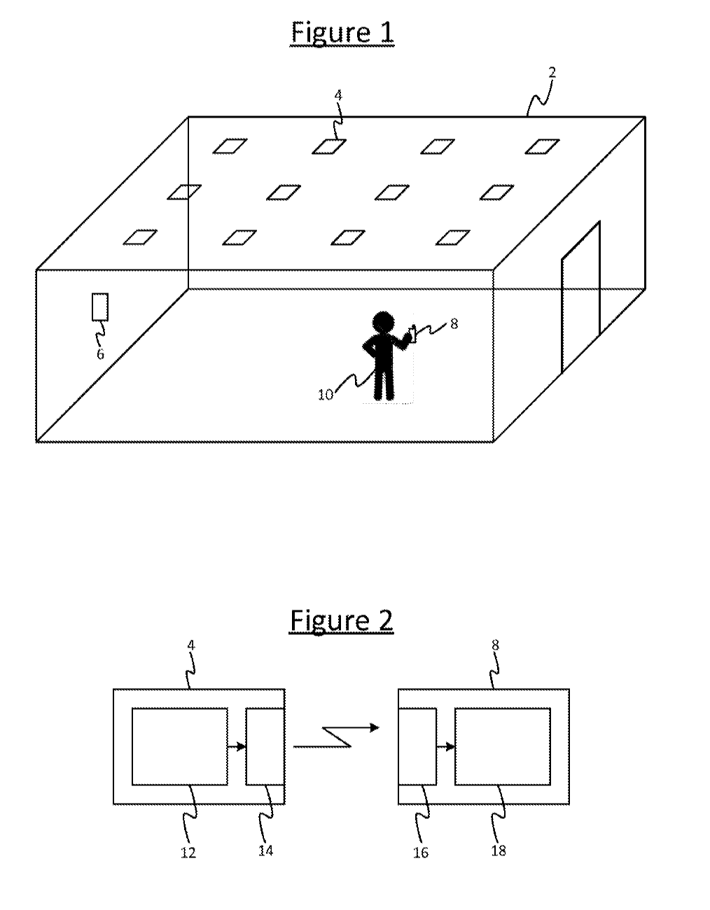

FIG. 1 illustrates an example of a localization network implemented through a lighting system by means of coded light. The lighting system comprises a plurality of luminaires 4 installed or otherwise disposed at different respective locations within an environment 2. For example the environment 2 may comprise an indoor space such as one or more rooms, corridors and/or halls; or an outdoor space such as a garden, park, sports field and/or campus; or a partially covered space such as a stadium; or any combination of such spaces or others. Each of the luminaires 4 comprises at least one lamp (i.e. the luminous element) and any associated socket, housing and/or support; with the lamp taking any suitable form such as a string or array of LEDs, or an incandescent bulb. Each of the luminaires 4 may for example take the form of a ceiling or wall mounted light fixture, or a free standing unit. The luminaires 4 have a primary function of providing illumination for illuminating the environment 2, so that human occupants can see within the environment 2.

Furthermore, each of some or all of the luminaires 4 is configured to embed a signal into the illumination it emits (e.g. by amplitude modulation, frequency modulation or phase modulation). Particularly, in the example of the localization network, each of these luminaires 4 is allocated an identifier (ID) that is unique within the system in question, and each such luminaire 4 is configured to continually broadcast its ID into the environment encoded into the respective illumination which it emits.

If a mobile device 8 is present in the environment 2 and equipped with a suitable coded light receiver, e.g. a rolling-shutter camera plus associated coded light decoder application, then the mobile device 8 can detect the IDs of any luminaires 4 in range. Using the respective ID(s), the mobile device 8 then looks up the locations of one or more of the detected luminaires 4 in a look-up table or other database mapping the IDs to the respective locations within the environment 2 (e.g. in terms of map grid reference or location on a floorplan). For instance the table or database may be stored locally on the mobile device 8, or the mobile device may access the table or database from a remote location such as a server (comprising one or more server units at one or more sites). E.g. the mobile device 8 may access the table or database via a communications network such as the Internet, by forming a wireless connection to that network via a wireless access point or router 6 disposed within the environment 2. This may be achieved using any suitable wireless access technology, e.g. a radio access technology such as Wi-Fi, 802.15.4, ZigBee or Bluetooth.

From this information on the location of one or more of the luminaire(s) 4, the mobile device 8 can also make an estimate of its own location. For instance, this may be achieved by assuming the location of the mobile device 8 is approximately that of the nearest or only visible luminaire 4 (e.g. the nearest can be determined based on signal strength or time of flight measurements of the received signals). Or to get a more refined estimate, the mobile device 8 may determine its location by combining measurements (such as the signal strength or time of flight) of the signals received from multiple visible luminaires 4 using a technique such as triangulation, trilateration, multilateration or fingerprinting. As a variant of this, the mobile device 8 may submit measurements to a location server for the localization determination to be performed here (e.g. submitting the measurements over the Internet or another network via a wireless access point or router 6 in the environment 2).

In many applications of such technology, the mobile device 8 is a mobile user device 8 of a user 10, disposed about the user's person, and the estimate of the location of the mobile user device 8 is used as an estimate of the location of the user 10. E.g. the mobile user device 8 may be a smartphone, tablet or laptop carried by a user 10, or perhaps a tracking tag worn by the user 10.

It will be appreciated that this is just one example of an application of coded light, and the techniques disclosed herein are also applicable to any other applications where the division of data amongst short packets is desired. E.g. in another application, the IDs emitted by one or more of the luminaires 4 may be used by the mobile device 8 to look-up other location-related information such as information on an exhibit in a particular room of a museum, or location related price information; or such information may even be embedded directly into the illumination from the luminaires 4 rather than requiring a look up based on ID. In another example application, the IDs emitted by the luminaires 4 may be used by a commissioning technician—with suitable device 8 and application—to isolate a respective illumination footprint in the environment 2 due to each of the different luminaires 4, and to use this information to inform the commissioning process. In yet further alternative or additional embodiments, the data being transmitted may comprise data other than an ID.

FIG. 2 gives a block diagram of a communication system comprising a transmitting device, e.g. a light source such as one of the luminaires 4 of FIG. 1; and a receiving device, e.g. a mobile user terminal 8 such as that shown in FIG. 1. The transmitting device 4 comprises a transmitter 14, e.g. a light source such as the lamp of a luminaire; and a controller 12 for controlling the transmitter 14 to transmit data to the receiving device 8, e.g. by means of coded light. The receiving device 8 comprises a receiver 16 receiving the data from the transmitting device 4, e.g. a light detector such as a rolling-shutter camera; and a decoder 18 for processing the data received via the receiver 16. The decoder 18 has at least the role of identifying which of a sequence of packets the received data belongs to, as will be exemplified in more detail shortly, and in embodiments may also have other roles, such as coded light demodulation.

In embodiments each of the controller 12 and the decoder 18 may take the form of software stored on one or more memory devices of the transmitting device 4 and receiving device 8 respectively, arranged to run on one or more processors of the transmitting device 4 and receiving device 8 respectively (memory and processors not shown). However, it is not excluded that one or both of these components could instead be implemented wholly or partially in dedicated hardware circuitry, or hardware configurable or reconfigurable circuitry such as a PGA or FPGA, or a combination of hardware and software.

The following will discuss a particularly advantageous application of the packetization scheme of the present disclosure, in which the transmitter 14 is a coded light source and the receiver 16 is a rolling-shutter cameras such as often found in smartphones and tablets.

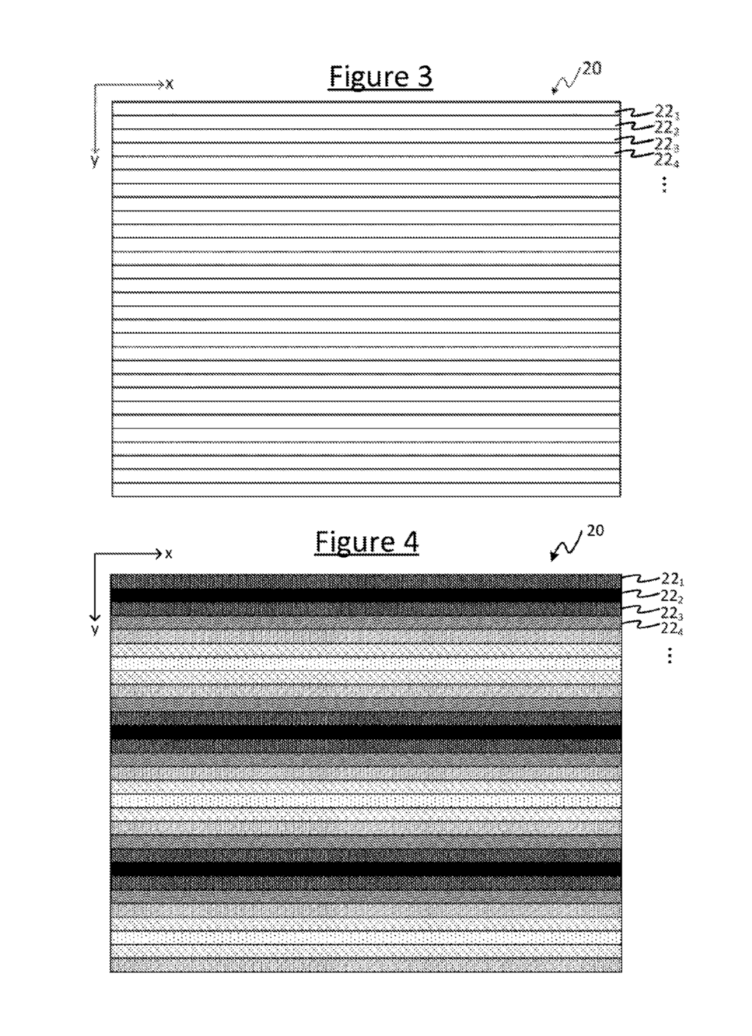

FIG. 3 represents the image capture element 20 of the camera 16. The image capture element 20 comprises an array of pixels for capturing signals representative of light incident on each pixel, e.g. typically a square or rectangular array of square or rectangular pixels. In a rolling-shutter camera, the pixels are arranged into a plurality of lines, e.g. horizontal rows 22. To capture a frame each line 22 is exposed in sequence, each for a successive instance of the camera's exposure time Tₑₓₚ. In this case the exposure time is the duration of the exposure of an individual line. Note of course that in the context of a digital camera, the terminology “expose” or “exposure” does not refer to a mechanical shuttering or such like (from which the terminology historically originated), but rather the time when the line is actively being used to capture or sample the light from the environment. Note also that a sequence in the present disclosure means a temporal sequence, i.e. so the exposure of each line starts at a slightly different time (and optionally the exposure of the lines may overlap in time). For example first the top row 22₁ begins to be exposed for duration Tₑₓₚ, then at a slightly later time the second row down 22₂ begins to exposed for Tₑₓₚ, then at a slightly later time again the third row down 22₃ begins to be exposed for Tₑₓₚ, and so forth until the bottom row has been exposed. This process is then repeated to expose a sequence of frames.

In WO2012/127439 for example, it has been described how coded light can be detected using a conventional video camera of this type. The signal detection exploits the rolling shutter image capture, which causes temporal light modulations to translate to spatial intensity variations over successive image rows.

This is illustrated schematically FIG. 4. As each successive line 22 is exposed, it is exposed at a slightly different time and therefore (if the line rate is high enough compared to the modulation frequency) at a slightly different phase of the modulation. Thus each line 22 is exposed to a respective instantaneous level of the modulated light. This results in a pattern of stripes which undulates or cycles with the modulation over a given frame (note that FIG. 4 is schematic and the scale is exaggerated here for illustrative purposes—typically there would be a larger number of much finer lines, and the modulation would be more dense). Based on this principle, the image analysis module 14 is able to detect coded light components modulated into light received by the camera 10.

However, as the image capture element 20 only has a finite number of lines 22, then without resorting to complex reassembly/stitching algorithms to stitch together data from multiple frame, this places a limit on the length of message that can be received in a single frame. In fact, typically the coded light source 4 will not fill the entire frame as shown in FIG. 4, but rather will appear only in a small sub-area of the frame, covering only a small sub-group of the lines 22, thus limiting the length of message even further.

As discussed, coded light can be used for a number of applications, such as having the coded light transmitters send a signal that can be used to identify the source of the emissions. E.g. each of the luminaires 4 may emit an ID of itself to be detected by a mobile user terminal 8.

The ID of each luminaire 4 can be sent as specific respective tone, but this is limited in the number of discrete identities that can be sent. In general, it is desirable to be able to send identities of a resolution equivalent to a number of bytes, which is beyond the capabilities of simple tone-based systems.

Current coded light systems have very limited transmission capacity. While transmission of a short ID signal may be sufficient for some applications, more recent applications have encountered a need to transmit a significantly longer ID over time. In the following scheme, to maintain system responsiveness, a long ID is sent as a number of shorter packets, and in embodiments each of these packets may also serve as a short, local ID. This scheme however brings a need to send indexing information to clarify which part of the longer ID any given packet is carrying. The following shows how such indexing can be provided by a single bit per packet.

Several methods of sending multibyte IDs can be implemented, but one such example is the transmission of an identity signal known as an Assigned Identifier. This is a field of variable length up to sixteen octets. The coded light protocol may also be a layered protocol so transmitted packets may contain headers and other overheads pertaining to those layers. Both of these aspects conflict with the need for short packets to enable fast detection with a camera.

One example of a protocol optimized for camera detection, has a mode of operation in which very short packets, containing only an Assigned Identifier and no other source payload, can be compressed so that all layer overheads are stripped and only the raw Assigned Identifier is transmitted. This is illustrated in FIG. 6(d), where a higher layer packet 30, forming the data 32 to be transmitted, is packaged into the payload 52 of a physical layer packet 50. A variant on this appends a short CRC 54 as a means of error protection. This mode of operation allows relatively fast detection (of the order of a second or so) of an Assigned Identifier. This and the other examples of FIG. 6 will be discussed in more detail later.

For unambiguous detection at the receive side 8, the length of packets that can be compressed is very short: e.g. up to four octets if a CRC is also carried and up to five if not. This is sufficient to carry an identity that can be locally unique: that is, the probability that another local transmitter sends the same identity is vanishingly small. This depends on the definition of ‘local’ and the process by which identities are assigned, but it is assumed in the following embodiments that the condition of local uniqueness holds.

Regardless, the four to five octet packet length is not sufficient to carry an identity that is globally unique, i.e. that there is no other transmitter in the world that sends the same identity. For this, at least 64 bits is required and it is notable that IPv6 uses addresses of 128 bits in length. The only way to send such long Assigned Identifiers, while retaining the short transmission format optimized for fast detection is to send them in pieces: a long ID of length 64 bits could be sent in two parts of length 32 bits, for example.

An issue with this method is identifying which part of the long identifier is being carried by any given transmission. In the example just quoted, a single bit would enable the decoder 18 at the receiving device 8 to determine which half of the long ID is being carried. On the other hand, if a 128-bit ID is transmitted in single octets, then using conventional techniques this would require four bits to identify which octet is being carried by any given transmission.

In a resource-constrained system such as compressed coded light, a single spare bit is hard to find; four bits even more so. Nevertheless, if a single spare bit can be found, then embodiments disclosed herein enable this to be used to determine the position in the long ID.

The technique is based on the principle of trading off bit capacity for time taken to determine one's position in a sequence. In the second example above, although, using a single bit, it is not possible to determine one's position from a single transmission, it is possible to do so from four successive transmissions. This is so because the single bit is arrangement to follow a special sequence that has the property that any four successive bits within a cycle of 16 exhibits a different 4-bit pattern. Thus, the pattern that emerges from four transmissions is enough to give an index.

In embodiments, the transmitting device 4 sends packets of information according to a regular cycle. Packets may take the form exemplified by the following table, which contains four elements: a sync field to allow the decoder 18 at the receiving device 8 to detect the start of the packet and align its own clock with that of the transmitter; a header field that may indicate the type of packet, and supply addressing information and other information that helps the receiver decide whether to process the packet and, if so, how; a data field of a format specified in accordance with the header; and a checksum field that allows the receiver to check for correct reception of the packet.

| | | | | |
|---|---|---|---|---|
| 101010 . . . 1101 | xxxx | I-bit | <data #> | <crc> |

| | | | |
|---|---|---|---|
| Sync field | Header | Data (payload) | Checksum |

Note that this is just one example, and other systems may deviate considerably from this due to protocol requirements, channel requirements and so on. For example, that the channel may be wired or wireless, radio or optical. It may operate as a point-to-point link or as a shared resource. Transmissions may be one-way (e.g. broadcast) or two-way.

For the purpose of the following discussion, the fields of note are the I-bit field of the header and the data field. It may be assumed that at least part of the data field is part of a repeating cycle of information, which may be generated by the end-user or by the transmitting device 4, e.g. by an application running on the transmitting device 4.

In an example system that embodies the present disclosure, the data field is used to send cyclic system information of different types in a carousel comprising 16 frames, and the I-bit is a single bit used to provide an indication of the current position of the carousel. A simple approach is to set the I-bit to ‘1’ at the start of the cycle and ‘0’ at all other times.

This provides an indication of when the cycle starts, but no further information during the rest of the cycle. Therefore instead, in embodiments a more preferable sequence takes the form described in the table below.

| | Data | | |
|---|---|---|---|
| | sequence | Current and next | |
| I-bit | number | three I-bits | |
| 0 | 0 | 0000 | 0 |
| 0 | 1 | 0001 | 1 |
| 0 | 2 | 0010 | 2 |
| 0 | 3 | 0100 | 4 |
| 1 | 4 | 1001 | 9 |
| 0 | 5 | 0011 | 3 |
| 0 | 6 | 0110 | 6 |
| 1 | 7 | 1101 | D |
| 1 | 8 | 1010 | A |
| 0 | 9 | 0101 | 5 |
| 1 | A | 1011 | B |
| 0 | B | 0111 | 7 |
| 1 | C | 1111 | F |
| 1 | D | 1110 | E |
| 1 | E | 1100 | C |
| 1 | F | 1000 | 8 |

The idea of the I-bit is that four successive I-bits combine to form one of 16 possible combinations, as shown in the table in binary and, for convenience, hexadecimal. Thus, by reading four successive I-bits, which may be referred to herein as an index value, it is possible to identify one's place in the sequence. Each index value is used to index a different respective one of the 16 packets being transmitted in a repeated cycle. For reasons that will elaborated on below, in embodiments a convention is adopted that the four-bit index value identifies the sequence location at the first I-bit. Thus, an index value of ‘0000’ marks data sequence location 0, while ‘1011’ marks data sequence location A. Note that this is just one example convention. In another for example, the location at the end of the four-bit window may be indexed. In this case, ‘0000’ identifies location 3, etc.

In preferred embodiments, a Maximum Length Sequence (MSL) may be used as the basis for the index sequence. Maximum Length Sequences (MLS) have an interesting property that derives directly from one method of generation. In this method, a Linear Feedback Shift Register (LFSR) is used with an arrangement of taps that feeds back a modulo-2 sum of weighted register values, such that, as the register is shifted and one bit output, a new bit, being the modulo-2 sum, is input at the other side.

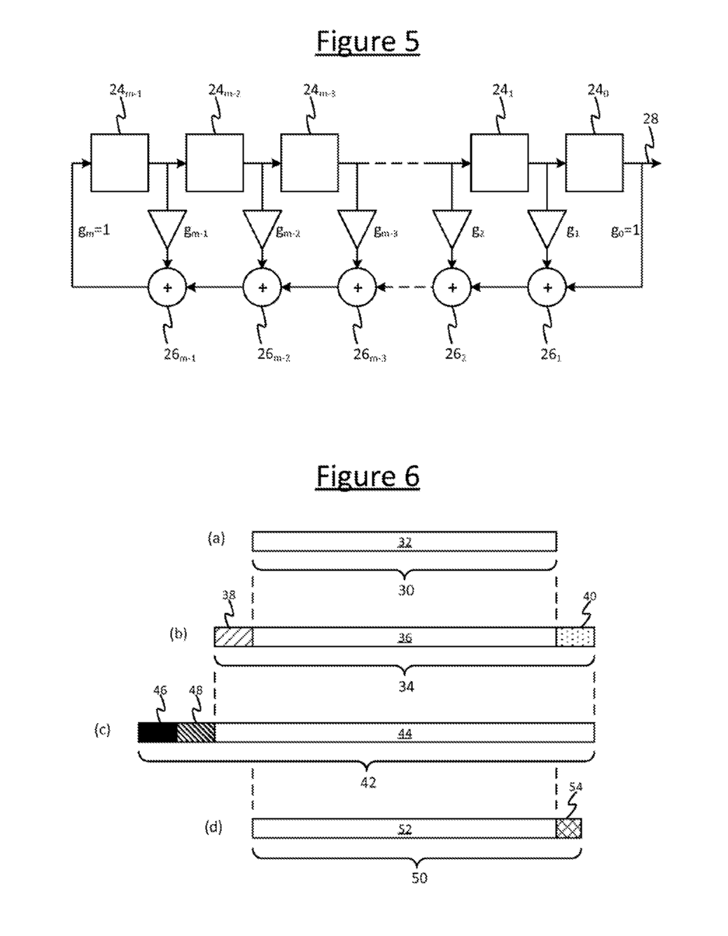

An implementation of a LSFR is shown in FIG. 5. The LFSR comprises a sequence of m 1-bit registers 24ₘ₋₁ . . . 24₀ connected in series, with the output of each 1-bit register 24ₘ₋₁ . . . 24₁ being connected to the input of the next, and the output of the last 1-bit register 24₀ providing the output 28 of the LFSR. As well as this, the output of each of the registers 24ₘ₋₁ . . . 24₀ (all but the last 24₀) is fed back via a respective weighting gₘ₋₁ . . . g₁. There is also a weighting g₀ at the output of the last 1-bit register 24₀, and a weighting gₘ at the input to the fits 1-bit register 24m−1, both of which are equal to 1. The outputs of these weightings gₘ₋₁ . . . g₁ are all summed together via respective modulo-2 summing stages 26ₘ₋₁ . . . 26₁. I.e. g₀ and the output of g₁ are summed by modulo-2 summing stage 26₁, then the output of this is summed with the output of g₂ by modulo-2 summing stage 26₂, then the output of this is summed with the output of g₃, and so forth, until the output of modulo-2 summing stage 26ₘ₋₁ is fed back to the input of the first 1-bit register 24ₘ₋₁ where the weighting g₀ is set to 1. This arrangement is known as a Fibonacci LFSR.

The weights are simply 1 or 0, so it can be said equivalently that a tap is present or is not. For an n-bit LFSR, certain tap combinations result in a generated, non-repeating sequence of output bits of length 2̂n−1. Such a sequence is known as a Maximum Length Sequence, or m-sequence.

Different valid tap combinations result in different m-sequences but all such m-sequences have several properties in common. A property that is very relevant for the present disclosure may be summarized as follows: a sliding window of length m, passed along an m-sequence for 2̂m−1 positions, will span every possible m-bit number, except all zeros, once and only once. That is, every state of an m-bit state register will be encountered, with the exception of all zeros.

The all zeros state represents an empty register. This state cannot occur as part of an MLS because no new 1s can be generated by the feedback network and, thus, the LFSR will never leave this state.

In the table above, it can thus be seen that the combination of current plus next few succeeding I-bits implements a sliding window of length m, where, in this case, m=4. The 16-bit sequence is derived from the 15-bit maximum length sequence {000100110101111} (generated from the polynomial x̂4+X+1) by adding an extra 0 so that the all zeroes state is now also included.

M-sequences of other lengths can be used but, since not every information carousel will have a length of 2̂m−1, the ability to uses sequences of yet other lengths is preferable.

Consider the m-sequence {011} (m=2). Using a sliding window of length 2, one obtains three index values of {01, 11, 10}. Now note that, in the case of the value {01}, it is sufficient to read the first 0 because there is no index value {00} so, on average, one needs to read around 1.7 bits. This can be extended to the index sequence {0011}, thus giving us an extra index value of {00} (and requiring us always to read 2 bits). One can also shorten it to the two-bit sequence {0, 1} (for which reading 1 bit is sufficient).

Similarly, the sequence {0011101} (m=3), with a sliding window of length 3, gives seven index values of {001, 011, 111, 110, 101, 010, 100}. Again, in the case of {001}, reading the first two zeros gives an unambiguous reading because the value {000} is not present. Thus one needs to read, on average, 2.9 bits. As before, this can be extended this to allow {000}, or it can be shortened by removing one of the 1s to {001101} or {000111}. In the former case, one obtains index values of {00, 011, 11, 101, 010, 100} and an average of 2.7 bits. In the latter case, one obtains index values of {000, 001, 01, 111, 110, 10} for a similar average but different set of index values.

In general, then, index sequences are not unique for a given length and more than one can be constructed. There is also no particular requirement to derive index sequences from m-sequences, e.g. one can also derive them from the more general de Bruijn sequences.

Further note that the start of an index sequence is arbitrary. By way of a convention, one can suggest that an index sequence is considered to start at the beginning of the longest sequence of zeros within it, but other conventions are possible.

The following table lists example index sequences and the corresponding index values for lengths up to 16. Longer sequences are known (and, in fact, may be simply derived from longer m-sequences) but, for brevity, not listed here.

| | | | Mean |
|---|---|---|---|
| Sequence | | | value |
| length | Index sequence | Index values | length |
| 2 | 01 | 0, 1 | 1 |
| 3 | 011 | 0, 11, 10 | 1.7 |
| 4 | 0011 | 00, 01, 11, 10 | 2 |
| 5 | 00111 | 00, 01, 111, 110, 100 | 2.4 |
| 6 | 001101 | 00, 011, 11, 101, 010, 100 | 2.7 |
| 7 | 0011101 | 00, 011, 111, 110, 101, 010, 100 | 2.9 |
| 8 | 00011101 | 000, 001, 011, 111, 110, 101, 010, 100 | 3 |
| 9 | 000111101 | 000, 001, 011, 1111, 1110, 110, 101, 010, 100 | 3.2 |
| 10 | 0000111101 | 0000, 0001, 001, 011, 1111, 1110, 110, 101, 010, 100 | 3.4 |
| 11 | 00010111101 | 000, 001, 0101, 1011, 011, 1111, 1110, 110, 1010, | 3.54 |
| | | 0100, 100 | |
| 12 | 000010111101 | 0000, 0001, 001, 0101, 1011, 011, 1111, 1110, 110, | 3.67 |
| | | 1010, 0100, 1000 | |
| 13 | 0001101111001 | 000, 0011, 0110, 1101, 101, 0111, 1111, 1110, | 3.77 |
| | | 1100, 1001, 0010, 010, 1000 | |
| 14 | 00001101111001 | 0000, 0001, 0011, 0110, 1101, 101, 0111, 1111, | 3.86 |
| | | 1110, 1100, 1001, 0010, 010, 1000 | |
| 15 | 000100110101111 | 000, 0010, 0100, 1001, 0011, 0110, 1101, 1010, | 3.93 |
| | | 0101, 1011, 0111, 1111, 1110, 1100, 1000 | |
| 16 | 0000100110101111 | 0000, 0001, 0010, 0100, 1001, 0011, 0110, 1101, | 4 |
| | | 1010, 0101, 1011, 0111, 1111, 1110, 1100, 1000 | |

Although the above description focuses on single-bit indexing, it is possible to extend this to multibit indexing when more bits are available. For example, if it is possible to send two bits per packet, then a four-bit index value can be received in two packets. For this to work, the second bit is placed two steps away from the first so that in two packets, all four bits of an index value are sent without duplication. Alternatively, an alphabet consisting of three or four symbols, for example, the set {A, B, C, D}, could be used, sending one such symbol with each packet. As an illustration, the 16-symbol de Bruijn sequence [AABBCCACDDADBDCB] includes all 16 possible 2-symbol combinations. Other combinations of multi-bit indexing and index sequence length are also possible. Note, where it is said that only a single bit or only a portion of the index sequence is used as an identifier field, this means the identifier field of the packet protocol in question, for identifying it amongst the other packets being sent within the same index sequence. It is not necessarily excluded that other kinds of identifier could be present for other purposes. For instance there could be other types of identifier for other purposes at different protocol layers. If the packet wraps up a lower level protocol in its payload, any header info of the lower protocol layer is now considered just payload data for the packet protocol in question and does not form part of its identifier field. E.g. in embodiments above, the payload is an ID of the transmitting device 4 (e.g. luminaire). Similarly if the packets are wrapped up in a higher layer protocol, this would also involve an identifier of the higher level protocol. E.g. if the payload does not repeat per index sequence, but rather each repetition of the index sequence accompanies a different payload, then the protocol could additionally include a frame identifier for distinguishing between different repetitions of the sequence. Or as another example, each repetition of the index sequence could optionally be accompanied by an overall identifier of the sequence as a whole in order to restore some of the random access character of the signal. E.g. each cycle (each group of packets indexed by a given instance of the index sequence) may be preceded in the transmission by an identifier identifying the group of packets carried in that cycle. That way, the decoder 18 at the receiving device 8 may be provided with the option of either synchronizing to packet sequence by detecting the overall cycle-identifier at the beginning of the sequence, and/or by tracking the index sequence if it starts receiving the packets mid-way through the sequence.

Some example packet formats are illustrated in FIG. 6. FIG. 6(a) represents a higher layer packet 30 of a higher layer protocol. From the perspective of the lower layer packet protocol in question, this simply amounts to the data 32 to be transmitted. This higher layer packet 30 may simply comprise a portion of the desired content (e.g. the ID of the transmitter 4), or may comprise this content data plus protocol data of a higher layer (header and/or tail information of a higher layer protocol). Either way, the lower layer protocol does not distinguish between higher layer protocol data (if any) and content data.

FIG. 6(b) illustrates a MAC layer protocol in which the data 32 (the higher layer packet 30) becomes the payload 36 of a MAC layer packet 34. The MAC layer packet 34 further comprises a MAC header 38, and a checksum 40 (e.g. CRC code) generated based on the MAC header 38 and payload 36. As shown in FIG. 6(c), in order to actually transmit the MAC packet 34, the whole MAC packet 34 becomes the payload 44 of a physical layer packet 42. The physical layer packet 42 also comprises header information in the form of a sync field 46 and a physical layer header 48.

Alternatively, as shown in FIG. 6(d), in a very resource constrained scenario, the MAC layer header 38 and checksum 40 may remain unused, or be stripped away, and instead only the higher layer packet 30 forms the payload of the physical layer packet 50.

Optionally, a physical layer checksum 54 may be included in this alternative physical layer packet 50, generated based on only the higher layer packet 30 and not the MAC header 38 (unlike the checksum 40 which is generated based on both the higher layer packet 32 and the MAC header 38). This alternative physical packet may be useful, for example, for rolling shutter camera detection.

Regarding the index-bit or the portion of the index sequence that is used to index the packet in accordance with the present disclosure, this may be included in the data field 32 in the examples of FIG. 6(c) or 6(d), or may be included as a new field or in a free field of the physical layer header 48 in the example of FIG. 6(c), or may be added as an additional field (not shown) to the alternative packet structure of FIG. 6(d) (if a spare bit or so can be found). Either way, space can be very limited so there is a motivation for single-bit indexing, or at least indexing based on only a small portion of an index sequence, as taught herein.

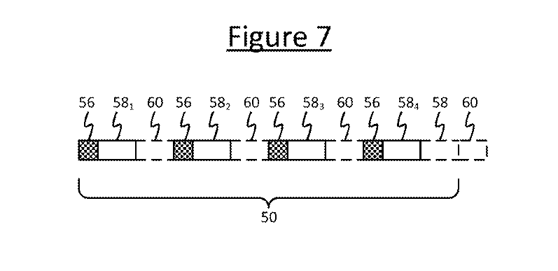

Note, in embodiments such as that of FIG. 6(d), optionally a dedicated sync field 46 need not be included as such, and instead the synchronization may be achieved based on other predetermined knowledge of the structure of the physical layer packets or a group of such packets (N.B. synchronization here refers the receiver synchronizing to the received signal at the physical layer, rather than synchronizing the packet position to the index sequence as in the rest of this disclosure). For instance, FIG. 7 shows an example in which the physical layer packet 50 is divided into individual octets (which may be referred to as

Physical-layer Service Data Units, PSDUs) and sent as a separate sub-packet 56 with a header bit 56 (which may be referred to as the Message Indicator, MI). The message indicator bit 56 is used for synchronization purposes. Thus, a data packet 50 is sent as a stream of 9-bit words, with a further, optional 9-bit word with a PDSU carrying an 8-bit CRC checksum 54. Further, each sub-packet is followed by an idle period 60. This complete structure is then repeated a number of times or for a defined period, with an extra idle period 62 between repetitions. The length of idle periods 60 between PSDUs and the idle period 60 between repetitions of the overall structure are designed to promote easy recovery by a rolling shutter camera.

Alternatively however, the packet 50 of FIG. 6(d) could be prefixed with a dedicated sync field similarly to that 46 of FIG. 6(c).

Whatever packet format is used, one issue that may be a consideration in embodiments is that errors may cause the index sequence to be disrupted. Tolerance of errors very much depends on the application in question, but if errors are a concern, then there are measures that may be taken to detect them and to re-find one's position in the index sequence.

One point to note is that the index sequence repeats, and also in fact, in embodiments such as those using an MLS, the index sequence allows one's place in the sequence to be determined from fewer bits than the length of the sequence (e.g. 4 in the case of a 15 bit MLS). Hence after occurrence of an error affecting the index sequence, the decoder 18 at the receiving device 8 can resynchronize to a subsequent repetition of the index sequence or even a later part of the index sequence (e.g. in the case of a 15 bit MLS, the decoder 8 only needs to see 4 consecutive bits of the index sequence to know its place in the sequence). Further, in embodiments the index sequence accompanies a corresponding, fixed-length carousel that would repeatedly transmit the same payload (e.g. a long ID) with each repetition of the index sequence. Thus, there is inherent redundancy in the data itself. But even in the case of an arbitrary, variable-length, ad-hoc carousel that transmits different payloads over different repetitions of the index sequence, if loss of some data is tolerable to the designer of the application in question, then the index sequence still allows the decoder 18 to resynchronize to the sequence to continue receiving subsequent transmissions correctly after occurrence of the error.

Consider for example a carousel of length 15 that uses an MLS of length 15 as the index sequence: 0 0 0 1 0 0 1 1 0 1 0 1 1 1 1. The index positions may be numbered from 0 to 14. A single bit from that sequence is transmitted with each packet. In general, the decoder 18 at the receive side 8 needs four successive packets to be able to identify its place in the sequence (the exception is the case of three successive ‘0’s because that can only occur in one place, so only three successive bits are needed). In absence of error, the receiving device 8 should receive a sequence ‘0, 0, 0, 1, 0, 0, 1, 1, 0, . . . ’, which translates to index positions of [x, x, 2, 3, 4, 5, 6, 7, 8, . . . ] (where ‘x’ indicates that there is not yet enough information to determine the place in the sequence). But what might go wrong is that:
an erased index bit is received (i.e. packet received but not successfully decoded—a “don't know” indication is generated),
an index bit is lost (i.e. packet not received), or
an index bit is flipped (i.e. an undetected packet error occurs).

In embodiments, a checksum 40 or 54 such as a CRC code is generated at controller 12 of the transmitting device 4 and included in the packet 42 or 50 respectively. In this case the decoder 18 at the receiving device 8 comprises a corresponding checksum checking function, such as a CRC check. The checking function detects whether the received checksum matches a corresponding checksum generated based on the received packet. If not, this is indicative that an error has occurred in transmission.

An erased index bit occurs if the packet checksum check fails and generates a notification of this event. In this case the decoder 18 can know the index bit is bad, and will not assume it knows its place in the sequence until it has received enough subsequent bits (e.g. 3 or 4 in the example of a 15 bit index sequence given above, or 4 in the case of a 16 bit index sequence).

A lost index bit on the other hand occurs if the checksum fails (which is one definition of “packet not received”) but no notification is generated, or if the receiver simply fails to hear the packet (e.g. sync not detected).

A flipped index bit could occur if the checksum passes the checksum check despite an error within the packet. Provided that the index bit is covered by a packet checksum, flipped index bits should be negligibly rare, but are technically possible. Also, a flipped bit would of course also go undetected if no checksum is used.

Lost and flipped index bits are more problematic than erased bits, because the decoder 18 cannot tell that the index bit may be wrong or missing. For instance if a packet was not received, then the decoder receives the subsequent packet after that with the subsequent index bit in the sequence, but does not know there was a missing index bit that failed to be received in between. E.g. referring to the above example of a 15 bit MLS, instead of reading ‘0, 0, 0, 1’ to arrive at index 3, the decoder 18 might lose the ‘1’ and read, ‘0, 0, 0, 0’ instead—so it loses synchronization with the sequence as well as losing the indexing information itself.

However, in embodiments, the index sequence itself advantageously also provides a mechanism for detecting errors, even in cases where a checksum is not used or the checksum does not help. That is, if the decoder 18 continues to track the index value, then it can detect that an error occurred previously—either because there is a jump in the index value or because it reads an invalid index. Based on this detection, the decoder 18 can then restart the indexing process. Furthermore, this detection allows the decoder 18 not only to resynchronize from the present point in the sequence, but potentially also to determine that a past interpretation of the index sequence was incorrect due to an error, and in response to discard the corresponding past data. In embodiments, the decoder 18 may wait to detect a plurality of successive valid index values before making this decision, to reduce the chance that it actually discards a correct past interpretation based on a current error.

Thus the index sequence enables resynchronization to the sequence even in presence of errors. This may take extra time, but the decoder 18 can always resynchronize eventually as long as the sequence continues.

In the above, there are also disclosed possibilities for sending more than one bit as the index portion of each packet. For example, in the 15-bit MLS scheme above, if there are two bits per available per packet for index information, the controller 12 of the transmitting device 4 could send bit [n] and bit [n−2] of the index sequence in packet Pn. In the next Pn+1, it could then send bit [n+1] and bit [n−1] of the index sequence. Thus, in two messages, the decoder 18 at the receiving device 8 gets the four bits it needs to compute an index position. Error detection and recovery can also be quicker in such embodiments, though error detection is still based on finding inconsistencies in the index sequence and/or illegal indices. Nonetheless, such a two (or multi) bit index portion does also provide an extra mechanism in that, since each index bit is effectively sent twice (or multiple times), the decoder 18 can also use inconsistencies in such received bits to detect dropped packets.

Burst errors may cause loss of data as well as loss of the index. Use of appropriate error detection methods like the packet checksum mentioned earlier would avoid poisoning the well with bad index values, but the index recovery process needs to start afresh.

Turning to another matter, the schemes disclosed herein can be used for either broadcast transmission or end-to-end transmission. The former need not require any particular additional protocol between transmitter and receiver, but in embodiments the latter may do. Particularly, many end-to-end transmission systems between two specific transmitting and receiving end-points may involve a mechanism of acknowledgment and retransmission, whereby the receiving device acknowledges receipt of each successfully received packet, and if the transmitting device does not receive an acknowledgment of a given packet, it retransmits that packet. A retransmitted packet has the potential to disrupt the index sequence of the present disclosure. E.g. perhaps the receiving device sends an acknowledgment but the acknowledgment is lost, so that the transmitting device re-transmits the packet which will contain the same index sequence. The problem could simply be tolerated, as eventually the decode will resynchronize to the correct index sequence as further packets are received. However, if it is desired to avoid this problem, the decoder at the receiving device needs a way to detect that the re-transmitted packet is a re-transmission of a previously received packet and not a new packet.

One solution makes use of a counter or sequence number field that may be present in the packet structure for other reasons, such as in the packet structure shown in FIGS. 6(b) and (c). Such a field may be used by a higher layer protocol or application for other purposes and hence may not be suitable for use to identify the packet, but may still give an indication of whether a packet is a retransmission of an already-transmitted packet.

Referring to the packet format of FIG. 6(b), which then becomes the payload of the physical layer packet shown in FIG. 6(c), one possibility is to use the sequence number field in the MAC header 48, which increments by 1 modulo 256 with every new transmission (i.e. for repetitions it stays the same, allowing the receiver to detect the retransmission). However, this is also shared with all traffic that uses this transmitter, meaning that, in general, it is not safe to use this as an index for a single service. Therefore an additional mechanism is still required to index the packet for the purposes of the particular application in question, and so the single-bit indexing (or reduced-bit indexing) using the index sequence of the present disclosure is still applicable.

Another consideration is that in embodiments there may be multiple transmitting devices 4 emitting into the same environment 2, a plurality of which may fall within range of the receiver. For instance, in some applications such as coded light, there can be several transmitting devices in the same environment 2 each radiating their own individual identity. In the case of coded light, a receiving device 8 may use the ability of the camera 16 to discriminate between such transmitting devices (in this case luminaires 4) to obtain a very precise indication of the location and trajectory of each respective signal. I.e. if the luminaires 4 appear as discrete elements in the captured image, the decoder 18 at the receiving device 8 can distinguish between the different signal sources 4 on this basis. In other examples using light, RF or other transmission media, other multiple access techniques could be used, such as by arranging for the signals from the different transmitting devices 4 to be transmitted on different modulation frequencies or in different time slots, or even using a code division multiple access technique.

In some embodiments, with multiple transmitting devices 4 radiating signals, it may be arranged that these signals are synchronized to each other, so that they will all step through the same index sequence in parallel. In this case, one possibility is that the receiving device 8 can recover the index by reading the index bit or portion from the packets transmitted by a plurality of the transmitting devices 4. This can add robustness, since if the index bit or portion is lost or corrupted in one or more packets from one or more of the transmitting devices 4, the decoder 18 may still be able to track the index sequence using the packets from one or more others of the transmitting devices 4.

Another possibility in the case of multiple transmitting devices 4, is that sub-parts of a long ID may be sent in a carousel arranged such that a sub-part can be enough to provide local uniqueness and can be sent much more quickly than the full identity. A possible problem with this is that the local uniqueness of any given sub-identity is adversely affected by the number of sub-identities that a full identity is broken down into. For example, a 16-bit identity, on its own, could permit up to 65536 lamps or luminaires in a given area to be uniquely identified. If these identities are randomly assigned, the ‘birthday paradox’ means that the effective number is much less, if identities are not allowed to clash. With 50 lamps, the probability of collision is already around 2%, which may be the limit for some applications. If a 128-bit identity is broken down into eight 16-bit identities, the problem is much worse because each lamp generates 8 sub-identities, meaning that the probability of collision is around 2% with only six or seven lamps (we should note that there is a probability of self-collision—that is, a probability that at least one lamp has two or more identical sub-identities—which can be discounted from the probability that one lamp's identities clashes with those of another.

This lost capacity may be recovered if the sub-identities are indexed. One can then say that identities can only collide if they occur at the same position in the carousel.

Single-bit indexing with an index sequence of length 8 can provide a solution here. However, in order to avoid having to read three successive packets from one transmitter, a considerate operator would arrange for all lamps to transmit in broad synchronism with each other. This would allow a user to read packets from three lamps one after the other, recovering three locally-unique sub-identities and the phase of the carousel.

Yet another possibility enabled by embodiments of the present disclosure is blind detection. One might expect the receiving device to need to know a) the length of an index sequence in operation, b) the sequence itself and c) the start point. In fact, knowing that an I-bit is in use (or more generally a reduced index portion from an index sequence), the decoder 18 at the receiving device 8 may obtain the first two parameters by direct observation (by observing how often the sequence repeats and what that repeating sequence is). Further, to identify the start point, any suitable convention may be used for the first index value in the sequence, such as starting the index sequence with the longest sub-sequence of 0s.

A further possibility to note is that, for any given sequence length, there are several possible index sequences that could be used. In embodiments, the choice as to which index sequence is selected (from amongst a set of different index sequences with the same length) may be used by the controller 12 at the transmitting device 4 to convey additional information in the transmission. This selection can then be detected and interpreted by the decoder 18 at the receiving device 8, e.g. being pre-configured with a look-up table mapping a meaning to each of the different possible sequences. Or at least, even if the index sequence is not selected explicitly at the transmitting device 4 for the purpose of conveying information, the decoder 18 at the receiving device 8 may be able to detect which sequence is being used and infer information about the transmitting device 4 or the transmission from this (e.g. again being pre-configured with a look-up table). Either way, by examining which particular sequence a transmitting device 4 is using, the receiving device 8 may thus be able to glean extra information, for example, the nature of the information that is being sent within the carousel, and/or some aspect of the transmitting device's operating conditions, and/or any other information about the transmission or transmitting device 4.

As yet another point, note that if no spare bit is available, it is possible to carry the I-bit in the data field (“in band”). This might necessitate ‘stealing’ a bit from the data, e.g., sending 15-bit sub-identities instead of 16-bit ones. However in some applications this may be tolerable.

It will be appreciated that the above embodiments have been described by way of example only.

In embodiments each of the portions is insufficient (too few bits) to identify the respective packet. However, in some other embodiments this is not necessarily true of all the packets in the sequence. E.g. consider an example where a 3-bit MLS is used to index a set of seven packets, but only 2 index bits are sent per packet. This gives four possible 2-bit index combinations, three of which appear twice, the fourth only once. If the receiver sees the fourth combination, it can know exactly where it is in the sequence without reference to anything else. Hence more generally, it may be said that at least one of the portions of the sequence is insufficient to identify the respective packet, and in embodiments each of some or all of the portions is insufficient to identify the respective packet.

Single-bit indexing (or more generally reduced-bit indexing) assumes shared context at transmitter and receiver. In embodiments, this may be achieved pre-configuring the transmitting device 4 and receiving device 8 to assume the same protocol, thus not necessarily requiring any handshaking or two-way communication between the transmitting and receiving devices 4, 8 (e.g. in a broadcasting arrangement). Alternatively, if a two-way service is available, it becomes possible for the transmitting device 4 and receiving device 8 to negotiate one or more parameters such as what sequence is being used, how long it is and, perhaps, what is carried in each slot. Error retransmission also becomes possible though probably by means of detecting CRC failure rather than anomalies in the index sequence.

Furthermore, in some alternative applications, the coded light emitter 4 might not have an illumination function at all. In that case, visible light or invisible infra-red light can be used as the medium for transmitting the messages. Further, the techniques disclosed herein may also be applied outside the field of coded light, to communications systems using other transmission media, such as, but not limited to, radio. For example, the disclosed scheme could be used to transmit an ID or other signal in the emission from an active ultrasound or infrared presence sensor (or each of multiple such sensors).

An example of a broadcast carousel outside the field of coded light is DECT (Digital enhanced Cordless Telecommunications), as specified in EN 300 175.

Communication between a DECT Fixed Part and DECT Portable Part is done in accordance with a TDMA frame structure established by the Fixed Part. The frame structure provides 24 time slots that are typically paired to comprise a duplex channel. DECT packets are exchanged in said timeslots, each packet comprising, amongst other things, an A-field that is normally used to carry DECT system information and a B-field that is normally used to carry user information. The Fixed Part uses the A-field to send cyclic system information of different types in a carousel comprising 16 frames, which collectively make up a DECT multiframe. A subfield within the A-field could be used to carry the index bit or portion of the present disclosure. N.B. applying single bit indexing or the like here may involve an update to the DECT standard.

Generally the techniques disclosed herein may be used in any communication system using light or other transmission media, and especially in any resource-constrained communication systems, depending on the constraints of the protocol, transmission medium, transmitter and/or receiver (not just limited by the constraints placed on coded light by rolling shutter detection). E.g. another example of a resource constraint is the availability of header bits in a packet protocol having a predetermined format. Typically, header bits are a scarce resource within a larger packet. In the case of DECT the protocol for example, this places a constraint on the packet size, making it a candidate for indexing based on reduced number of index bits in accordance with the present disclosure.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A transmitting device comprising:
a transmitter for transmitting data to a receiving device; and
a controller for formatting the data to be transmitted from the transmitter, by dividing the data amongst a plurality of packets;
wherein the controller is configured to package each respective one of the packets with only a respective portion of an index sequence as an identifier field for distinguishing between the packets within the sequence, such that one of the portions is alone insufficient to identify a respective position in the index sequence for its respective packet; and
wherein the controller is further configured to control the transmitter to transmit the packets including the respective portions of the index sequence, ordered such that the index sequence repeats cyclically over the transmission of the packets; thereby enabling the receiving device to determine a respective position in the index sequence for each of the packets by referencing a plurality of the portions together.

2. The transmitting device of claim 1, wherein the transmitter comprises a light source for emitting light, and the controller comprises a controller of the light source configured to perform said transmission by modulating the packets into the light emitted by the light source.

3. The transmitting device of claim 2, wherein the transmitting device comprises a luminaire, the light source comprises a lamp for emitting illumination to illuminate an environment, and the controller comprises a controller of the luminaire configured to perform said transmission by modulating the message into the illumination emitted by the lamp.

4. A receiving device comprising:
a receiver for receiving data from a transmitting device, the data being received divided amongst a plurality of packets; and
a decoder for extracting the data from the packets;
wherein each respective one of the packets is received packaged with only a respective portion of an index sequence as an identifier field for distinguishing between the packets within the sequence, such that one of the portions is alone insufficient to identify a respective position in the index sequence for its respective packet; and
wherein the decoder is configured to determine a respective position in the index sequence for each of the packets by referencing a plurality of the portions together.

5. The receiving device of claim 4, wherein the packets are modulated into light from a light source, and said receiver comprises a light sensing unit for receiving the packets by sensing said light.

6. The receiving device of claim 5, wherein the light sensing unit comprises a rolling shutter camera.

7. The receiving device of claim 4, wherein the decoder is configured to determine the position in the sequence by:
for each one of said packets, determining a respective index value by combining the respective portion of the index sequence with the respective portions received in a plurality of others of the received packets at predetermined points in the index sequence relative to said one of the packets, wherein the index value gives an unambiguous position within the index sequence.

8. The receiving device of claim 7, wherein the decoder is configured to detect that an earlier determination of the position was incorrect, based on detecting that the respective index value is illegal within the sequence or that the respective index value of one or more later packets is inconsistent relative to the respective index value of one or more earlier packets in context of said index sequence.

9. The transmitting or receiving device of claim 1, wherein each of said portions is a fixed size.

10. The transmitting or receiving device of claim 1, wherein each of said portions is a single bit.

11. The transmitting or receiving device of claim 1, wherein over each repetition of the index sequence, the data of each respective packet consists of a different respective part of an overall payload.

12. The transmitting or receiving device of claim 11, wherein the overall payload repeats with each repetition of the index sequence.

13. The transmitting or receiving device of claim 1, wherein the index sequence is a Maximum Length Sequence or a derivative thereof.

14. A system comprising:
a transmitting device according to claim 1, and
a receiving device.

15. (canceled)

16. (canceled)

17. A method of transmitting data to a receiving device, the method comprising:
formatting data to be transmitted to the receiving device, by dividing the data amongst a plurality of packets;
packaging each respective one of the packets with only a respective portion of an index sequence as an identifier field for distinguishing between the packets within the sequence, wherein one of the portions is alone insufficient to identify a respective position in the index sequence for its respective packet; and
transmitting the packets including the respective portions of the index sequence, ordered such that the index sequence repeats cyclically over the transmission of the packets, thereby enabling the receiving device to determine a respective position in the index sequence for each of the packets by referencing a plurality of the portions together.

18. (canceled)
